(19) United States
(12) Patent Application Publication
(10) Pub. No.: US 2007/0287049 A1
(43) Pub. Date: Dec. 13, 2007

(54) Fuel Cell with Non-Fluorinated or Partly Fluorinated Membrane and Method for Preparing Said Membrane

(75) Inventor: Nathalie Cornet, Voisins Le Bretonneux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Bjoulogne Billancourt (FR)

(21) Appl. No.: 11/576,662

(22) PCT Filed: Oct. 6, 2005
(86) PCT No.: PCT/FR05/50816

§ 371 Date: Apr. 4, 2007

(30) Foreign Application Priority Data
Oct. 6, 2004 (FR) 0410520

(51) Int. Cl. H01M 8/10

(52) U.S. Cl. 429/33; 429/46

(57) ABSTRACT

The invention concerns a fuel cell with non-fluorinated or partly fluorinated membrane wherein said membrane comprises a non-fluorinated or partly fluorinated polymer and an antioxidant for protecting said polymer against the free radicals formed. The invention also concerns methods for obtaining such fuel cells.

The present invention relates to the field of fuel cells, more particularly fuel cells with nonfluorinated or partly fluorinated membranes, and also methods enabling such membranes to be obtained.

Fuel cells are generally formed from an assembly of cells and comprise, in a central position, a membrane electrode assembly (MEA). The membrane of this assembly provides an essential role in transporting protons from one electrode to the other. Thus, the properties of such a membrane therefore determine the characteristics of the fuel cell. Furthermore, the membrane must meet numerous mechanical and physicochemical criteria (for example, ionic conductivity, lower permeability to the gases used in the fuel cell and efficient separation of the gases, and thermal stability) and also economic and environmental criteria.

Most of the membranes used are perfluorinated membranes comprising acid groups. These perfluorinated type membranes allow, in general, most of the technical criteria required to be met although their performance remains problematic at temperatures above 90° C. On the other hand the synthesis of perfluorinated membranes is often complex and requires the use of safety devices. Furthermore, recycling current perfluorinated membranes can be a problem.

It has therefore been proposed to develop membranes made from a nonfluorinated or partly fluorinated polymer, as described, for example, in Patent Application U.S. Pat. No. 5,985,942.

In recent years, numerous nonfluorinated membranes have been developed for use in fuel cells. For example, Patent Application EP 0 574 791 describes a membrane comprising a sulfonated aromatic polyetherketone. However, the main limitation of this type of membrane comprising carbon-based polymer chains is their limited stability in a fuel cell medium. This is because this medium has a high temperature and is very oxidizing, due to the presence of oxygen at the cathode.

The consequence of this is that the membrane used in the fuel cell medium tends to lose its mechanical and/or physicochemical properties, and to crack and/or break, thus resulting in a low efficiency of the cell, even in the cell ceasing to operate.

There is therefore a real need to provide membranes for fuel cells that have satisfactory mechanical and physicochemical properties while fulfilling the economic and environmental criteria.

One object of the present invention is to provide novel nonfluorinated or partly fluorinated membranes aiming to provide a solution to the stability problems in a fuel cell medium.

Another object of the present invention is to obtain a fuel cell comprising a membrane that has satisfactory mechanical and physicochemical properties, these properties being retained during prolonged use (5000 h) in a fuel cell while being of low cost and environmentally friendly.

Chain scission is generally preceded by the formation of free radicals on the polymer chains. A further object of the present invention is to limit or prevent chain scission by inhibiting the free radicals.

The fuel cell according to the invention is a fuel cell with a nonfluorinated or partly fluorinated membrane comprising a nonfluorinated or partly fluorinated polymer and an antioxidant enabling the polymer chains to be protected from the action of the free radicals present on the polymer.

Other advantages and features of the invention will appear on examining the detailed description of the embodiments and implementation methods, given by way of nonlimiting examples.

One of the principal reactions in the method of degradation of unsaturated polymer membranes is the addition of an HO• radical to aromatic rings, more particularly to the groups, for example alkyl or alkoxy groups, in the ortho position. The HO• radicals may also initiate the breaking of bonds such as —C—O—C— bonds.

Within the scope of the present invention, the membranes have a chemical structure that is sensitive to the presence of HO• radicals, preferably they are sulfonated carbon-based membranes comprising a polyaromatic polymer with arylsulfonic groups. Examples of such polymers that may be mentioned include:
polymers of the sulfonated polyetherketone (PEK) type, comprising units of formula (II), in which n represents an integer ranging from 20 to 500: 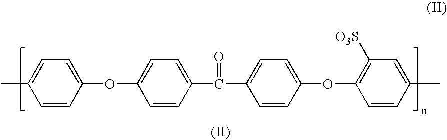
polymers of the radiation-grafted FEP-g-PSSA type, corresponding to the partly fluorinated type polymer, comprising units of formula (III), in which m represents an integer between 5 and 10, and p an integer between 3 and 10: 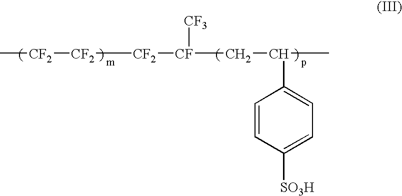
polymers of the sulfonated polyimide (PI) type comprising units of formula (IV) in which X represents an integer ranging from 1 to 9 with an X/Y ratio between 2/8 and 6/4: 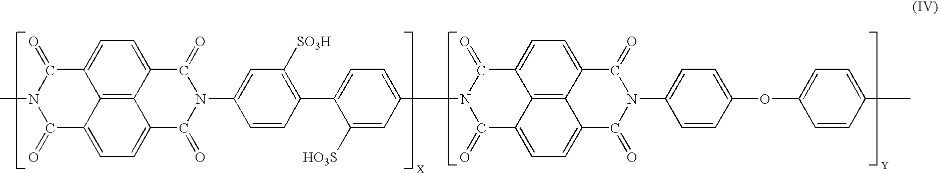
polymers of the sulfonated polyarylene ether sulfone (PSU) type comprising units of formula (V), in which k represents an integer ranging from 20 to 500: 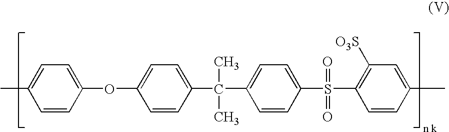
and polymers of the polystyrene/divinylbenzene sulfonic acid type comprising units of formula (VI):

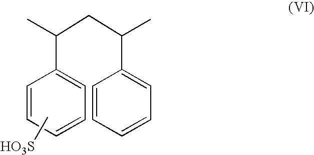

In the present invention, the groups present in the membranes that are sensitive to breaking are protected by the action of an antioxidant, for example chosen from hindered amine light stabilizers (HALS).

These light stabilizers probably act via an antioxidizing mechanism This is because these sterically hindered amines are easily oxidized leading to the formation of cationic amine radicals. These intermediates are converted, in the presence of oxygen and via various Intermediate peroxyl radicals, into nitroxyl radicals. These particularly long-lived radicals react effectively, as scavengers, with the free radicals present in the polymer of the membrane. This has the effect of interrupting the radical oxidation of the polymer chains and protects the latter against the deterioration generated by multiple chain scissions.

The stabilizing power of the hindered amine light stabilizers depends on their chemical structure and on their molecular weight. Their configuration will in fact define their accessibility to the site where the free radicals are found, that is to say their ability to stabilize said radicals. The type of stabilizer to use will depend therefore on the structure and the nature of the polymer. The performance of a stabilizer/polymer pair is for example determined experimentally by carrying out ageing tests in a fuel cell medium.

Hindered amine light stabilizers may for example be compounds of formula (I) below: 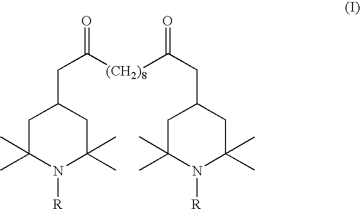
in which R represents a hydrogen atom, an alkyl radical, an acyl radical or an alkoxy radical, preferably a hydrogen atom or a methyl radical.

These amines have the common feature of a tetramethylpiperidine system that plays the part of capturing free radicals. The —N—R group becomes a nitroxyl radical NO•, then, during a cycle known as a “Denisov” cycle, these radicals react with the free radicals that are formed in the polymer exposed to its environment.

The light stabilizer is preferably of low molecular weight, for example with a molecular weight ranging from 300 to 600 g/mol. This light stabilizer is present in an amount ranging from 0.5 to 1% by weight relative to the weight of the polymer.

The fuel cells according to the present invention may comprise membranes of different structures.

For example, the antioxidant may be mixed with the polymer solution before the casting step that allows the membrane to be produced In this case, the antioxidant is present in the whole membrane, which enables the entirety of the membrane to be protected.

Another possibility is, for example, depositing a thin layer comprising the antioxidant mixed with the polymer onto one of the surfaces (the surface intended to be positioned against the cathode, of the membrane as it is drying. The attachment of the antioxidant presents little or no additional interfacial resistance. The layer comprising the antioxidant and the polymer has a thickness ranging from 2 to 10. The advantage of this embodiment of the invention is that the quantity of antioxidant used being limited, the final cost of the membrane will be reduced

### EXAMPLE

Synthesis of a Sulfonated Polyimide Type Membrane:

The synthesis of a sulfonated block polyimide was carried out in two steps in the same reactor.

The first step consisted in synthesizing the hydrophilic block by polycondensation of a dianhydride with a sulfonated diamine. The imidization was carried out by thermal processing at 180° C. for 15 hours, and the diamine used was not in acid form.

The synthesis of the hydrophobic block was carried out during the second step with the introduction of a hydrophobic diamine and of the same dianhydride that was used in the first step. The thermal imidization was carried out at 180° C. for 20 hours. The block polymer was obtained in solution in the synthesis solvent. The choice of solvent depends on the nature and the various structures of monomers used during the synthesis. Examples of solvents that can be used include, for example, phenol 3-chlorophenol or formamide. When the temperature of the polymer solution drops back to room temperature, the solution becomes viscous.

Generally, it is preferable to introduce the antioxidant once the synthesis of the polymer has been carried out so as not to disturb the synthesis. The antioxidant is introduced, for example, in liquid form into the polymer in solution that will be heated with stirring at 85° C.

The antioxidant chosen must be soluble in the solvent used in the synthesis, such as for example HALS 770 (Ciba). The antioxidant is introduced so as to keep the ratio between 0.5 and 1% by weight relative to the weight of the polymer.

The homogeneous solution obtained may then be formed, for example by heating then by casting and drying. The forming conditions are known and depend on the nature of the polymer used.

It is thus possible to obtain a membrane entirely composed of antioxidant and polymer, or a thinner layer that will be deposited on one surface of the membrane thus enabling the membrane to be protected from an initial destruction of its backbone during the fuel cell operating conditions.

1. A fuel cell with a nonfluorinated or partly fluorinated membrane, characterized in that said membrane comprises a nonfluorinated or partly fluorinated polymer and an antioxidant enabling said polymer to be protected from the free radicals formed.

2. The fuel cell as claimed in claim 1, characterized in that the antioxidant is a hindered amine type light stabilizer.

3. The fuel cell as claimed in claim 2, characterized in that the light stabilizer is a compound of general formula (I): 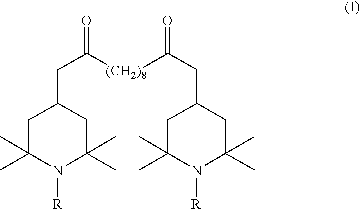
in which the R group represents a hydrogen atom, an alkyl radical, an acyl radical or an alkoxy radical.

4. The fuel cell as claimed in claim 3, characterized in that the R group represents a hydrogen atom or a methyl radical.

5. The fuel cell as claimed in claim 2, characterized in that the hindered amine type light stabilizer has a molecular weight ranging from 300 to 600 g/mol.

6. The fuel cell as claimed in claim 1, characterized in that the antioxidant is present in an amount ranging from 0.5 to 1% by weight relative to the weight of the nonfluorinated or partly fluorinated polymer.

7. The fuel cell as claimed in claim 1, characterized in that the nonfluorinated or partly fluorinated polymer is a polyaromatic polymer comprising arylsulfonic groups.

8. The fuel cell as claimed in claim 7, characterized in that the nonfluorinated polymer is chosen from:
polymers of the sulfonated polyetherketone type, comprising units of formula (II), in which n represents an integer ranging from 20 to 500: 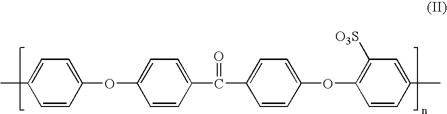
polymers of the sulfonated polyimide (PI) type comprising units of formula (IV) in which X represents an integer ranging from 1 to 9 with an X/Y ratio between 2,/8 and 6/4: 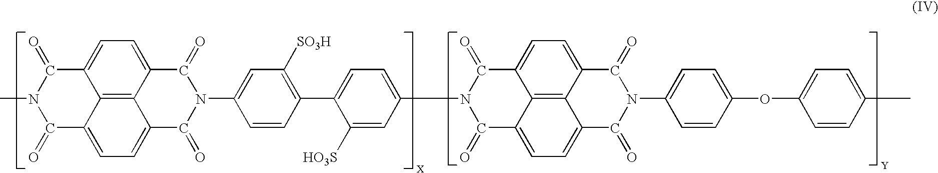
polymers of sulfonated polyarylene ether sulfone (PSU) type comprising k units of formula (V), in which k represents an integer ranging from 20 to 500: 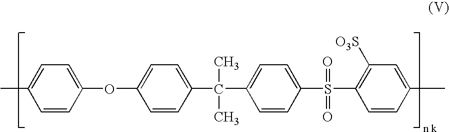
polymers of the polystyrene/divinylbenzene sulfone acid type comprising units of formula (VI):

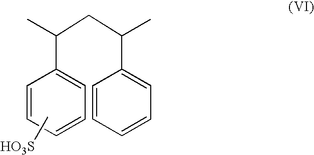

9. The fuel cell as claimed in claim 7, characterized in that the partly fluorinated polymer is a polymer of the radiation-grafted FEP-g-PSSA type comprising units of formula (III), in which m represents an integer between 5 and 10, and p an integer between 3 and 10:

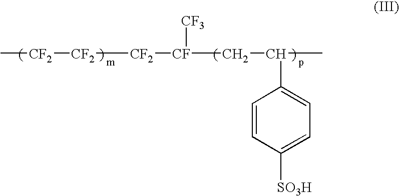

10. The fuel cell as claimed in claim 1, characterized in that the membrane is entirely composed of a polymer and antioxidant mixture.

11. The fuel cell as claimed in claim 1, characterized in that the membrane comprises on one of its surfaces a thin layer of a polymer and antioxidant mixture.

12. The fuel cell as claimed in claim 11, characterized in that the layer of the polymer and antioxidant mixture has a thickness ranging from 2 to 10 μm.

13. A method for preparing a fuel cell, characterized in that the antioxidant is mixed with the polymer before casting the membrane.

14. The method for preparing a fuel cell as claimed in claim 13, characterized in that the layer of the polymer and oxidant mixture is deposited on he membrane as it is drying.
